(19) United States
(12) Patent Application Publication
(10) Pub. No.: US 2019/0004163 A1
(43) Pub. Date: Jan. 3, 2019

(54) METHOD AND DEVICE FOR DETECTING AN ICE-COVERED ELECTROACOUSTIC SENSOR

(71) Applicant: Robert Bosch GmbH, Stuttgart (DE)

(72) Inventors: Marcus Schneider, Ludwigsburg (DE); Michael Schoenherr, Renningen-Malmsheim (DE)

(21) Appl. No.: 15/781,880

(22) PCT Filed: Oct. 12, 2016
(86) PCT No.: PCT/EP2016/074491

§ 371 Date: Jun. 6, 2018

(30) Foreign Application Priority Data
Dec. 9, 2015 (DE) 10 2015 224 733.3

(51) Int. Cl. G01S 7/52; G01S 7/521; G01S 15/93; B60Q 9/00

(52) U.S. Cl. CPC G01S 7/52004; G01S 7/521; G01S 2015/938; B60Q 9/00; G01S 2007/52009; G01S 15/931

(57) ABSTRACT

A method for detecting a diaphragm of an electroacoustic sensor covered with snow/ice (e.g., an ultrasonic sensor on a vehicle). The method includes: a) after a sensor operation start, a temperature sensor, disposed in the interior of a sensor housing, ascertains a temporal temperature characteristic of an interior of the electroacoustic sensor, where the temperature of the sensor interior at the beginning of the sensor operation is below 0° C. In b), a second time range of the ascertained temperature characteristic is detected by a processing unit in that the temperature increase drops significantly in comparison with a temporally preceding first range. In c), if such a time range is detected, then it is inferred therefrom that the diaphragm of the electroacoustic sensor is covered with snow/ice. In d), if it was detected that a diaphragm of the electroacoustic sensor is covered with snow/ice, a warning is output to the driver.

### FIELD OF THE INVENTION

The present invention relates to a method and a device for detecting an ice-covered electroacoustic sensor. According to a further aspect, the present invention relates to an electroacoustic sensor.

### BACKGROUND INFORMATION

In winter and in the case of vehicles that are parked outside, it may happen that an electroacoustic sensor, e.g., one that is part of a driver-assistance system as a distance sensor, is coated with ice or snow given the corresponding weather. If the electroacoustic sensor has an outwardly facing diaphragm for emitting and/or receiving sound waves, then an ice or snow coating on the diaphragm of the electroacoustic sensor may no longer permit the diaphragm of the sensor to vibrate freely, which means that less energy is converted into sound. An emitted pulse would be weaker than intended in such a case, and an arriving sound would induce vibrations that are weaker than without such a coating. Because of an ice coating on the diaphragm, the sound waves are furthermore absorbed and therefore no longer reach the sensor diaphragm in their entirety. An ice or snow coating of the diaphragm of the electroacoustic sensor may thus lead to a reduced sensitivity of the sensor or, in the worst case, to its failure.

Patent document DE 10 2010 028 009 A1 discusses an ultrasonic sensor for a distance measurement, in which the temperature gradient of a sensor surface is detected with the aid of a temperature sensor and analyzed. In the process, the temperature gradient is detected directly at the diaphragm and compared to a setpoint value. In this way the blocking of the surface by ice, for example, can be inferred. A heating device for ultrasonic sensors for the removal of adhering ice is described in addition.

As a consequence, it is believed to be understood from the related art to use temperature sensors at the diaphragm in order to infer an ice-coated sensor; however, the additional sensor system required for this purpose is very expensive and difficult to install.

### SUMMARY OF THE INVENTION

In order to solve this problem, the present invention provides a method for detecting a snow- or ice-covered diaphragm of an electroacoustic sensor on a vehicle, in particular an ultrasonic sensor. The method includes the following steps:
a) Following the start of the sensor operation, a temporal temperature characteristic of an interior of the electroacoustic sensor is ascertained with the aid of a temperature sensor, which is disposed in the interior of a housing of the sensor. The temperature of the sensor interior at the beginning of the sensor operation is below 0° C.
b) A processing unit identifies a second time range of the ascertained temperature characteristic during which the temperature increase drops significantly in comparison with a temporally preceding first range.
c) In the event that such a time range is identified, this leads to the conclusion that the diaphragm of the electroacoustic sensor is covered with snow or ice.
d) If it was detected that a diaphragm of the electroacoustic sensor is covered with snow or ice, then a warning is output to the driver.

The present method therefore makes it possible to detect an ice-covered sensor without the need to install an expensive additional sensor system in the vicinity of the diaphragm. According to the present invention, a temperature sensor is disposed in the interior of the housing of the sensor for this purpose, which is able to ascertain a temporal temperature characteristic of the interior space in order to thereby make it possible to detect an ice-coated or snow-coated sensor.

The present invention is based on the recognition that a coating of snow or ice on the diaphragm of the sensor causes a typical time characteristic of the temperature in the interior of the sensor housing. The reason for this is the melting process of the water when the ice/sludge/snow coating has reached a temperature of 0° C. At the start of the sensor operation, when the temperature at the diaphragm is still below 0° C., an approximately linear temperature increase of the sensor interior and also of the diaphragm of the sensor occurs to begin with. This linear temperature increase comes about because contacts on the circuit board of a sensor have a resistance so that electric energy thus is also converted into thermal energy when a current is flowing. As a rule, the sensor also has resistive electronic components, which likewise convert electrical energy into thermal energy. Depending on the specific thermal capacity, the temperature of the sensor interior and that of the components of the electroacoustic sensor heated by the waste heat consequently rises in an initially linear manner. This is followed by a time range during which a clear drop occurs in the temperature rise. This is attributable to the onset of a melting process of the ice on the diaphragm when the melting temperature of the ice is reached there. The temperature at the diaphragm during the melting process remains constant at approximately 0° C. and no longer rises. The heat is fully required as melting heat for the phase change, which is why no further rise in the temperature may occur there during the melting process. The diaphragm therefore turns into an isothermal heat sink, which cools the air of the sensor interior and thereby slows its warming by the waste heat. After a certain period of time, a linear increase in the temperature of the sensor interior occurs again since the melting ice causes a water film to build up on the diaphragm. This is due to the fact that the temperature of the water film begins to rise because of the heat storage, so that the air of the sensor interior also heats up again.

Similar considerations also apply to other configurations or other forms of installation of electroacoustic sensors.

The method according to the present invention may particularly be used for detecting an ice- or snow-covered diaphragm of an ultrasonic sensor as it is used in a vehicle for a distance measurement and/or for an environment detection.

Exemplary embodiments of the present invention are characterized by the features described herein.

The detection of the second time range may take place in the second step of the present method, during which the processing unit compares the gradient of the ascertained temperature characteristic in the sensor interior to the gradient of a reference temperature characteristic stored in the processing unit, and a difference in the curve characteristics is detected in the process. In order to allow for a plausible evaluation on the basis of the comparison and the difference in the curve characteristics, the reference temperature characteristic has the same temperature characteristic at the beginning of the comparison as the sensor interior at the start of the sensor operation. The gradient of a curve in one point is a meaningful feature of a curve characteristic by which the characteristic of two curves may be compared in a precise manner.

In one further, alternative development, the detection of the second time range, during which the processing unit compares the second derivation of the ascertained temperature characteristic in the interior of the sensor to the second derivation of a reference-temperature characteristic stored in the processing unit, takes place in a second step of the method, and a difference in the curve characteristics is detected in the process. In order to allow for a plausible evaluation on the basis of the comparison and the difference in the curve characteristics, the reference temperature characteristic has the same temperature at the beginning of the comparison as the sensor interior at the beginning of the sensor operation. The second derivation, and thus the determination of changes in the direction of the curve or of turning points within the curve, is a typical feature of a curve characteristic, which makes it easy to compare the characteristics of two curves.

In one embodiment of the present invention, the affected sensor is indicated to the driver, e.g., on a display, during the final step of the present method. This is particularly advantageous if multiple sensors are installed in the vehicle. If possible, the driver is therefore able to remove ice or snow from the affected sensor. In the event that the ice or snow cover has also damaged the sensor, then it will not be necessary for a repair to individually ascertain which particular sensor is defective. In addition, the driver himself is able to estimate which maneuvers may still be safely performed using the operative sensors, and which maneuvers may be carried out manually.

According to one further aspect of the present invention, an electroacoustic sensor, in particular an ultrasonic sensor, is provided. This electroacoustic sensor, for instance, is configured as a part of a driver-assistance system and is employed for a distance measurement. The electroacoustic sensor has a housing, a temperature sensor, and a diaphragm for receiving acoustic vibrations. The diaphragm may alternatively be used for emitting acoustic vibrations. In one further alternative, the diaphragm may be used for both principles. The diaphragm is disposed on the housing in such a way that it seals the housing toward the outside. The temperature sensor, which is situated in the interior of the housing according to the present invention, records the temporal temperature characteristic of the interior of the electroacoustic sensor once the sensor starts its operation. This implemented function therefore allows the execution of the first step of the present method, i.e. the ascertaining of the temporal temperature characteristic of the sensor interior.

The electroacoustic sensor configured according to the present invention also includes a processing unit, which is configured to detect a second time range of the temperature characteristic during which the temperature increase drops significantly in comparison with a preceding first time range. Furthermore, if such a temporal range is detected, the coating of the diaphragm with snow or ice is to be identified.

The processing unit may be provided either in the interior of the housing or separately from the housing.

The temperature sensor may be fixed in place on a circuit board of the sensor, the circuit board being situated in the interior of the housing. The circuit board ensures the contacting of the required electronics system of the electroacoustic sensor. In other words, the required voltage supply for the electronic components of the electroacoustic sensor is available there. The affixation of the temperature sensor on the circuit board also offers the advantage that no additional current supply has to be provided for the temperature sensor as the electronic component.

The temperature sensor may be mounted both as an individual component on the circuit board and be configured as a part of an integrated switching circuit that is situated in the electroacoustic sensor. Among other things, the mounting of the circuit board or the integration as a part of an integrated switching circuit offers the advantage that no additional component has to be fixed in place on the diaphragm itself. In this way the production of the diaphragm does not become more expensive in comparison with an electroacoustic sensor without the development according to the present invention.

In one embodiment of the present invention, the diaphragm of the electroacoustic sensor is configured as the base area of a diaphragm pot. This makes it possible to nearly completely decouple the vibration of the diaphragm from possible vibrations of other surrounding parts such as a bumper.

Exemplary embodiments of the present invention are illustrated in the figures and described in greater detail in the following description.

### BRIEF DESCRIPTION OF THE DRAWINGS

FIG. 1a shows a first specific embodiment of the present invention.

FIG. 1b shows typical temperature characteristics of the sensor interior with and without an ice coating of the diaphragm.

FIG. 2 shows an example for the implementation of the output of a warning to the driver when an ice- or snow-covered distance sensor is detected.

FIG. 3 shows a method sequence according to one embodiment of the present invention for detecting a diaphragm that is coated with snow or ice.

### DETAILED DESCRIPTION

In the following exemplary embodiments, identical features have been denoted by the same reference numerals.

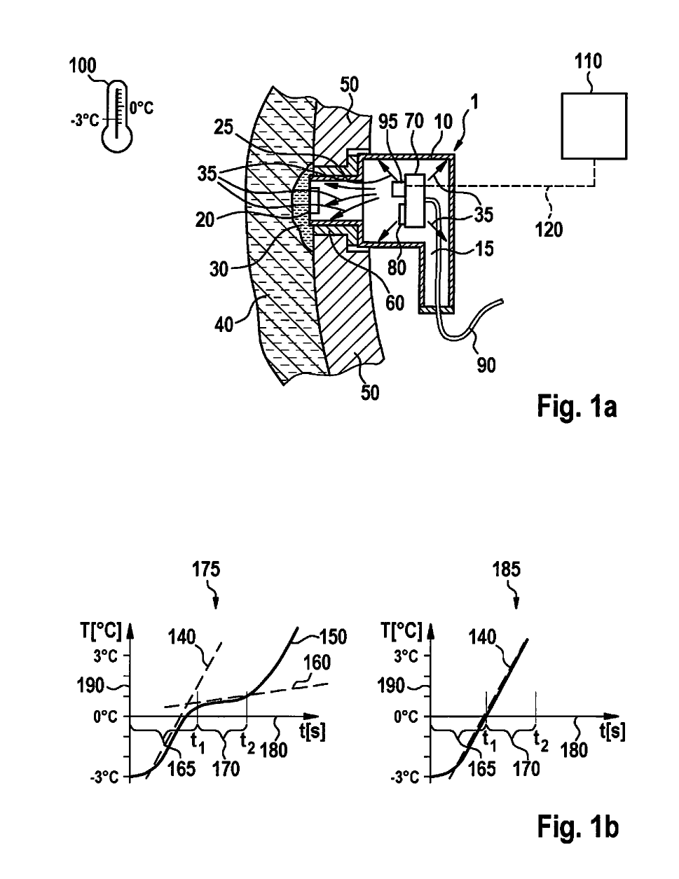

FIG. 1a shows an electroacoustic sensor 1, which includes a housing 10, a diaphragm 20 for receiving and/or emitting acoustic vibrations, a temperature sensor 80 in sensor interior 15, and a processing unit 95. In addition, a decoupling ring 60 is illustrated, which may be installed between diaphragm pot 25 and bumper 40 in order to seal the sensor on the one hand, and to decouple sensor 1 and bumper 40 with regard to mechanical vibrations on the other hand. Processing unit 95 as well as temperature sensor 80 may be contacted on a circuit board 70 in the sensor interior, as illustrated in this first embodiment. The circuit traces of circuit board 70 are supplied with current by a current cable 90, for example. During the operation of the sensor, the electrically supplied energy is predominantly converted into heat at the contacts of circuit board 70, and the heat is able to be dissipated into bumper 50 via diaphragm 20, housing 10 or via the sidewall of diaphragm pot 25.

Temperature sensor 80 is able to detect this heating through an increase in the temperature. Diaphragm 20, which is configured as a base area of diaphragm pot 25 in this example, is coated with ice 40 or snow at an external temperature 100 of −3° C. in this particular example.

Starting at a temperature of 0° C. of diaphragm 20, a melting process of ice 40 occurs during the sensor operation, which leads to the formation of a water film 30 on diaphragm 20 after a certain period of time. To the extent that it is dissipated via diaphragm 20, dissipated thermal energy 35 is utilized for this melting process. The temperature at the diaphragm remains at approximately 0° C. during the melting process, which results in a slowing of the heating of the air of sensor interior 15. As a result, the temperature of sensor interior 15 no longer rises as strongly for a certain period of time, which means that the gradient of the ascertained temperature characteristic is reduced. As water film 30 on diaphragm 20 continues to grow, the temperature of the water begins to rise as a result of the heat storage, whereupon the temperature at diaphragm 20 increases as well. As a consequence, the air of sensor interior 15 begins to heat more rapidly again.

The temperature-time characteristic of sensor interior 15, which has been measured by temperature sensor 80 in the meantime, is detected by a processing unit 95 and compared to a stored reference characteristic of a second, ice-free sensor, as illustrated in the following FIG. 1b. If a second time range 170 featuring a considerably lower gradient than in the reference curve is detected in ascertained temperature characteristic 150, then this makes it possible to identify a diaphragm 20 of electroacoustic sensor 1 that is covered with snow or ice 40. Processing unit 95 may then transmit a warning to an output device 110 via a data link 120 and have this warning as well as affected electroacoustic sensor 1, for instance, displayed to the driver.

On the left side of FIG. 1b, a measured temperature characteristic 150 of sensor interior 15 is shown over the time by way of example for electroacoustic sensor 1 depicted in FIG. 1a after the start of the sensor operation. In this instance, the temperature, using the unit of degree Celsius, has been plotted on Y-axis 190, and the time, in seconds, has been plotted on X-axis 180. In a first time range 165, which lasts from the start of the measurement (t=0) to instant t₁ and which corresponds to a period of 10 seconds, for example, the temperature of sensor interior 15 rises in an approximately linear fashion. The gradient of this first time range 165 is approximated by the gradient of first tangent 140. First time range 165 of reference temperature characteristic 200 of an ice-free sensor on right side 185 of FIG. 1b extends at approximately the same gradient as first time range 165 of the curve on left side 175.

The linear temperature increase in this first time range 165 comes about in that contacts on circuit board 70 exhibit an electrical resistance, which means that electrical energy is thereby also converted into thermal energy when a current is flowing. Depending on the specific thermal capacity, this causes the temperature of sensor interior 15 as well as the temperature of the components of electroacoustic sensor 1 heated by the waste heat to rise in a linear manner.

First time range 165 is followed on left side 175 at instant t₁ by a second time range 170 of ascertained temperature characteristic 150 of sensor interior 15, which has a characteristically different curve compared to its first time range 165. The temperature increase in this second time range 170, which corresponds to a time period of 10 seconds, for instance, has dropped considerably in comparison with first time range 165, which can also be gathered from the clearly flatter characteristic of second tangent 160 in comparison with first tangent 140. The gradient of second tangent 170 roughly describes the gradient within second time range 170, which extends up to instant t₂. In contrast, second time range 170 of reference temperature characteristic 200 of an ice-free sensor on right side 185 of FIG. 1b continues without change at a linear temperature increase that approximately corresponds to the gradient of first tangent 140. The reason for this different temperature characteristic is the beginning melting process of ice 40 that is disposed on diaphragm 20 from FIG. 1a. The temperature at diaphragm 20 remains constant at approximately 0° C. during the melting process and no longer rises. The heat is fully required for the phase change, which is why no further temperature increase is able to take place there in the interim. Diaphragm 20 thus becomes an isothermal heat sink, which slows the heating of sensor interior 15. In the case of an ice-free sensor, in which this cooling effect does not occur over a certain period of time, the temperature continues to increase in a linear fashion. This becomes clear from reference temperature characteristic 200 on right side 185 of FIG. 1b. A processing unit 95 is able to detect this difference in the characteristic of the two curves, which, in the case of ascertained temperature characteristic 150 on left side 175 of FIG. 1b, points to a diaphragm 20 that is coated with ice 40 or snow as already shown in the description of FIG. 1a, and may then be communicated to the driver in the form of a warning with the aid of an output device 110.

Following instant t₂, as water film 30 continues to grow, the heat storage in water film 30 begins, which causes the water to be heated so that the diaphragm temperature begins to rise again. The heating of sensor interior 15 is thereby no longer slowed because the warming water begins to warm the air of sensor interior 15 as well. As a result, the two temperature characteristics on left side 175 and on right side 185 of FIG. 1b approach each other again.

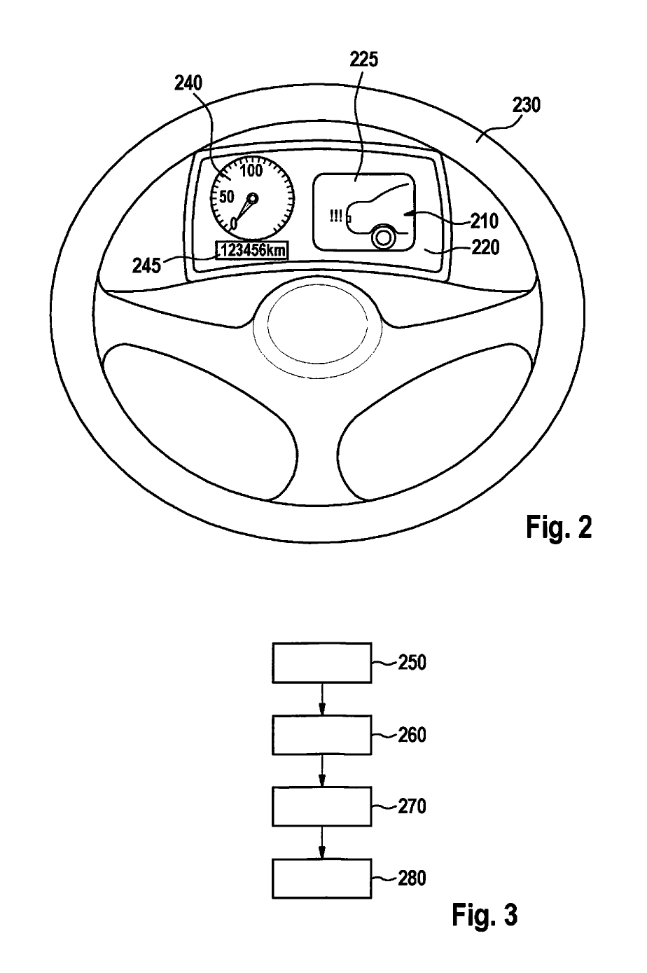

In FIG. 2, a steering wheel 230 and an instrument panel 220 having a display can be seen, on which a warning 210 to the driver, a mileage indicator 245, and tachometer 240 of the associated vehicle are displayed. Warning 210 to the driver, as illustrated in this FIG. 2, is able to be carried out by displaying a symbol on a display 225. This directly illustrates to the driver in the immediate visual field on instrument panel 220 the presence of an ice-covered sensor. At the same time, the position of affected sensor 215 may be shown by the representation on a display. If multiple sensors are installed in the vehicle, this makes it possible for the driver to remove the ice or snow from the affected sensor himself to the greatest extent possible. In the event that the sensor also has incurred damage as a result of the ice or snow coating, then there is no need to separately ascertain for repair purposes which particular sensor is defective. In addition, the driver may then evaluate for himself which maneuvers may still be safely carried out with the functioning sensors and which ones are better carried out manually.

FIG. 3 shows a method sequence according to the present invention for detecting a diaphragm of an electroacoustic sensor that is covered with snow or ice.

In the first step of method 250, after the start of the sensor operation, the temperature sensor, which is disposed in the interior of the electroacoustic sensor, ascertains the temporal temperature characteristic of the sensor interior. The temperature of the sensor interior at the start of the sensor operation is below 0° C.

In the second step of method 260, a processing unit detects a second time range of the previously ascertained temperature characteristic of the sensor interior. This second time range is characterized by a significant drop in comparison with a temporally preceding first range. The detection of this second range may advantageously take place with the aid of the processing unit, through a comparison with a reference temperature characteristic that has the same temperature at the start of the comparison as the sensor interior at the start of the sensor operation. For this purpose, the gradient and/or the second derivation of the two temperature characteristics may be compared to one another, for example.

If such a second time range was detected, then the detection of a diaphragm of the electroacoustic sensor that is covered with snow or ice takes place in the third step of method 260.

In the fourth step of method 280, a warning will then be output to the driver.

1-7. (canceled)

8. A method for detecting a diaphragm of an electroacoustic sensor covered with snow and/or ice, on a vehicle, the method comprising:
a) ascertaining a temporal temperature characteristic of an interior of the electroacoustic sensor after a start of sensor operation by a temperature sensor, which is situated in the interior of a housing of the sensor, the temperature of the sensor interior being below 0° C. at the start of the sensor operation;
b) detecting a second time range of the ascertained temperature characteristic, in which the temperature increase drops significantly in comparison with a temporally preceding first range, with a processing unit, and if such a time range is detected,
c) detecting a diaphragm of the electroacoustic sensor that is coated with snow and/or ice; and
d) outputting a warning to the driver.

9. The method of claim 8, wherein in task b), the detection of the second time range takes place in that the processing unit compares the gradient of the ascertained temperature characteristic to the gradient of a reference temperature characteristic stored in the processing unit, the reference temperature characteristic having the same temperature at the start of the comparison as the sensor interior at the start of the sensor operation.

10. The method of claim 8, wherein in task b), the detection of the second range takes place in that the processing unit compares the second derivation of the ascertained temperature characteristic to the second derivation of a reference temperature characteristic stored in the processing unit, the reference temperature characteristic having the same temperature at the start of the comparison as the sensor interior at the start of the sensor operation.

11. The method of claim 8, wherein in task d), the affected sensor is indicated to the driver.

12. An electroacoustic sensor, comprising:
a housing;
a diaphragm for receiving and/or emitting acoustic vibrations;
a temperature sensor; and
a processing unit;
wherein the temperature sensor is disposed in an interior of the housing, and the diaphragm is disposed on the housing so that it seals the housing towards the outside, and the temperature sensor is configured to detect a temporal temperature characteristic of an interior of the electroacoustic sensor after a start of the sensor operation, and
wherein the processing unit is configured to detect a second time range of the temperature characteristic in which the temperature increase drops significantly in comparison with a temporally preceding first range, and if such a time range is detected, it is to be detected that the diaphragm is coated with snow and/or ice.

13. The electroacoustic sensor of claim 12, wherein the temperature sensor is fixed in place on a circuit board of the sensor, and the circuit board is situated in the interior of the housing.

14. The electroacoustic sensor of claim 12, wherein the diaphragm includes a base area of a diaphragm pot.

15. The electroacoustic sensor of claim 12, wherein the electroacoustic sensor includes an ultrasonic sensor.

16. The method of claim 8, wherein the electroacoustic sensor includes an ultrasonic sensor.
